(19) United States
(12) Patent Application Publication
(10) Pub. No.: US 2007/0258755 A1
(43) Pub. Date: Nov. 8, 2007

(54) Framework connection set

(75) Inventors: Chien-Chung Chang, Taipei (TW); Yang-Li Fu, Taipei (TW)

Correspondence Address: BIRCH STEWART KOLASCH & BIRCH, PO BOX 747, FALLS CHURCH, VA, 22040-0747, US

(73) Assignee: Chien-Chung Chang

(21) Appl. No.: 11/417,057

(22) Filed: May 4, 2006

(51) Int. Cl. B25G 3/00

(52) U.S. Cl. 403/256

(57) ABSTRACT

A specialized configuration of a framework connection set is provided, which is capable of assembling and disassembling frameworks easily. The framework connection set includes a retainer and a retaining clamp. The retaining clamp is moved forward or backward onto the groove of the retainer so as to modulate the space between the retaining clamp and a retainer top section. The retaining clamp and the retainer top section grasp the flange of the ledger. By doing so, the frameworks are firmly connected by the retainer and the retaining clamp. On the other hand, when the retaining clamp is removed, the ledger flange loses contact with the retainer top section. Therefore, the frameworks are disassembled.

### BACKGROUND OF THE INVENTION

1. Field of the Invention

The present invention relates generally to a connection set, and more particularly to a framework connection set easy to assemble and disassemble the scaffolds. The framework connection set provides a simple construction process, which does not need to solder, and enable the connection set to be reusable in the meantime.

2. The Prior Arts

A scaffold is a temporary platform used to support people and materials in the construction or repair of buildings. It provides a place of work with safe access suitable for the work being done. In building construction, the vibration of scaffolds is usually caused by the operation of huge construction machines and other operations. It is important to have a stable framework set up so the workers can work safely.

A work platform of the scaffold includes a plurality of ledgers and a plurality of transoms, which rest upon the ledgers at right angles and provides support for platform boards. The conventional method of joining the ledgers and the transoms together is soldering or knotting. Soldering, no matter assembling or disassembling, needs skilled persons equipped with soldering tools and devices to operate. Therefore, it is expensive and time consuming. On the other hand, transoms cannot be knotted tightly to ledgers either. No matter what kind of wires being used, the knots are unable to avoid loosening or slipping between ledgers and transoms caused by the shaking of the scaffold. The unstable platforms and the uneven surface resulted from the knots not only increase the danger of the workers to stand on or pass by, but also make the stacked apparatus and materials unstable. Furthermore, knotting is also laborious and time consuming, and the wires used could not be reused again.

### SUMMARY OF THE INVENTION

The present invention intends to overcome the disadvantages of the prior art. The primary objective of the present invention is to provide a framework connection set without soldering, which significantly reduces time and labor cost for assembling and disassembling the frameworks. Another objective is to provide an even and stable work platform for workers to work on. The other objective of the present invention is to provide a reusable framework connection set avoiding the waste of knotting materials used in the prior art.

The present invention herein provides a framework connection set for easier framework connection and disconnection. The framework connection set includes a retainer and a retaining clamp. The retainer includes an approximately C-shaped foundation. The retainer comprises a connection part, a first opening, and at least a groove. The first opening is corresponding to a flange of a ledger to fit in, and the connection part is corresponding to a transom to be connected with. The retaining clamp is a wedge and it slides in the groove of the retainer. It can move the ledger flange close to or away from the retainer top section. Therefore, the retainer and retaining clamp make the ledger and transom connected together.

When connecting a plurality of ledgers and a plurality of transoms on the scaffold according to the present invention, each ledger and transom are first fitted respectively to the first opening and the connection part. The retaining clamp is then inserted onto the groove so that the clamp top surface moves close to the retainer top section. It makes the ledger flange securely fixed between the retainer top section and the retaining clamp, and firmly connected with the transom. On the other hand, when the retaining clamp is removed, the clamp top surface moves away from the retainer top section so as to loosen the connection.

According to the present invention, the only job for assembling or disassembling frameworks is to move the retaining clamp forward or backward. As a result, the costs of time and labor will be decreased by easy operation. Meanwhile, there is no soldering or knotting, thereby further reduction of the costs of needed devices and tools. In addition, the connection of the ledgers and the transoms according to the present invention would also enhance the rigidity of the scaffold for the safe working environment for the workers, and the stability and evenness of stacking surface for apparatus and materials to put on.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is an perspective view showing a framework connection set comprising a retainer and a retaining clamp according to a first embodiment of the present invention;

FIG. 1B is an perspective view showing an assembled framework connection set according to the first embodiment of the present invention;

FIG. 2A is an perspective view showing the connection of a transom and a ledger by the framework connection set according to the first embodiment of the present invention;

FIG. 2B is a sectional view of FIG. 2A showing an assembled framework;

FIG. 3 is a schematic view of a scaffold according to the first embodiment of the present invention;

FIG. 4A shows the connection of a transom and a ledger by the framework connection set according to a second embodiment of the present invention;

FIG. 4B is a sectional view of FIG. 4A showing an assembled framework;

FIG. 5A shows the connection of a transom and a ledger by the framework connection set according to a third embodiment of the present invention;

FIG. 5B is a sectional view of FIG. 5A showing an assembled framework;

FIG. 6A shows the connection of a transom and a ledger by the framework connection set according to a fourth embodiment of the present invention; and

FIG. 6B is a sectional view of FIG. 6A showing an assembled framework.

### DETAILED DESCRIPTION OF THE PREFERRED EMBODIMENT

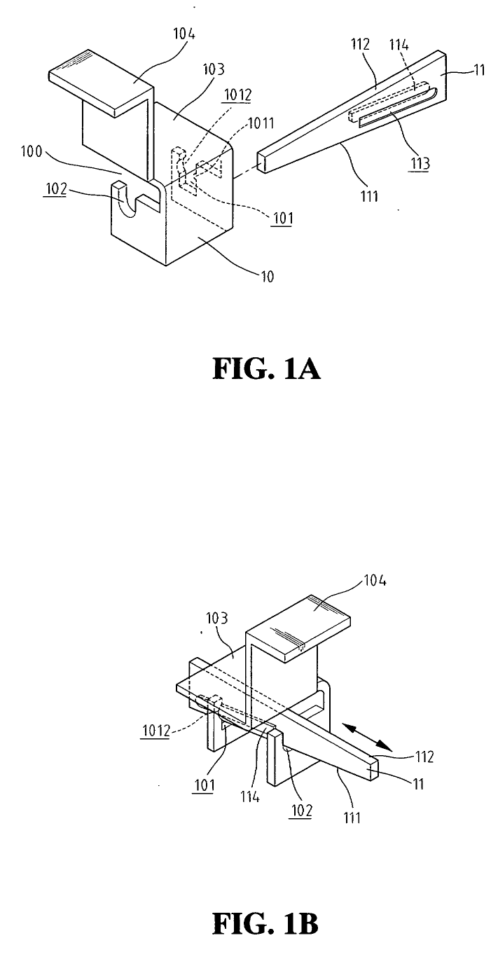

Referring to FIGS. 1-3, which show the framework connection set 1 and its application according to a first preferred embodiment of the present invention, the framework connection set 1 comprises a retainer 10 and a retaining clamp 11. The retaining clamp 11 is inserted into the retainer 10 to fasten a ledger 3 and a transom 4 together.

The lower part of retainer 10 is approximately C-shaped and comprises at least one groove. There are two grooves, a first groove 101 and a second groove 102, according to the first embodiment of the present invention. The first groove 101 is provided with a groove convex 1011 and a groove concave 1012, wherein the groove convex 1011 and groove concave 1012 are at opposite sides of the groove. The first groove 101 is cut deeper than the second groove 102. The retainer top section 103 is the top portion of the lower part of the retainer 10. A connection part 104, which is an inverted L shape, is the upper part of the retainer 10 and is connected to the edge of the retainer top section 103.

The retaining clamp 11, as a configuration of a wedge, has two opposite nonparallel surfaces, a clamp bottom surface 111 and a clamp top surface 112. The retaining clamp 11 also includes a clamp slot 113, which is corresponding to the groove convex 1011, and a clamp ridge 114, which is corresponding to the groove concave 1012. When inserting the retaining clamp 11 into retainer 10, the clamp bottom surface 111 rests upon the first groove 101 and the second groove 102. The clamp slot 113 and the clamp ridge 114 slide along the groove convex 1011 and the groove concave 1012 respectively, and are restrained therein.

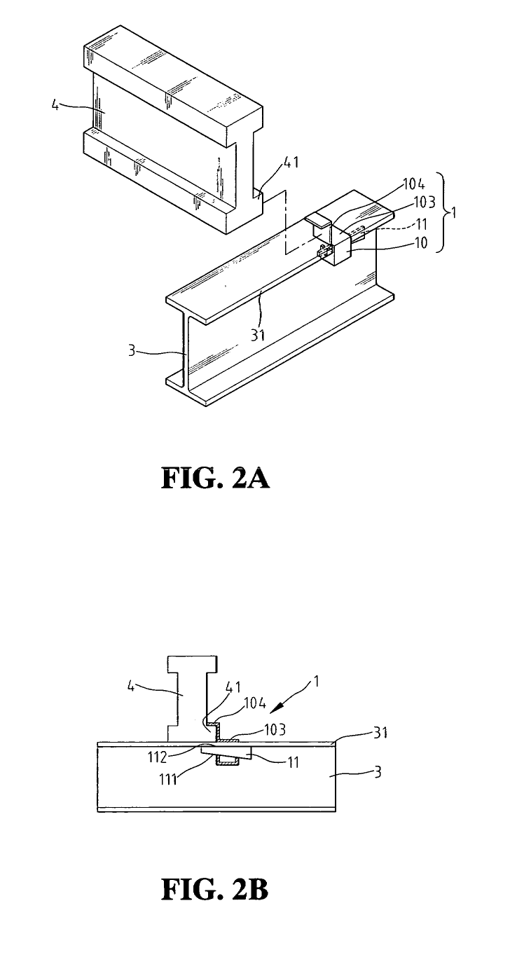

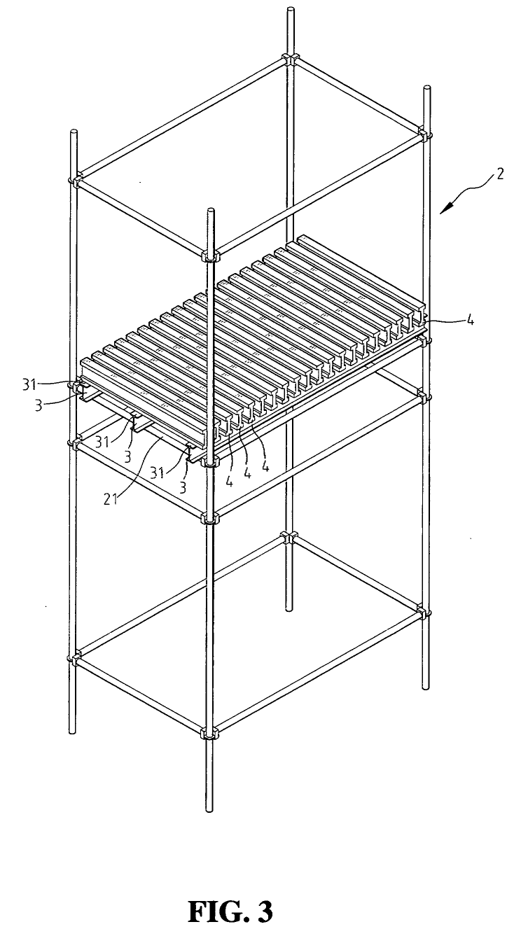

As shown in FIGS. 2A and 3, a scaffold 2 provides a plurality of rods 21 mounted thereon, a plurality of ledgers 3 mounted on the rods 21, and a plurality of transoms 4 arranged on the ledgers 3. When assembling the frameworks, a ledger flange 31 is fitted to the first opening 100 of the retainer 10, and then a transom flange 41 is fitted to the connection part 104 of the retainer 10 according to the first preferred embodiment. After inserting the retaining clamp 11 onto the first groove 101 and the second groove 102, the retaining clamp 11 pushes the ledger flange 31 to the retainer top section 103. The retaining clamp 11 and the retainer top section 13 grasp the ledger flange 31 firmly. Therefore, the ledger 3, the transom 4, the retainer 10 and retaining clamp 11 are connected together. In order to make the ledger 3 and the transom 4 fitted more securely, a hammer could be used to strike the end of the retaining clamp 11 to push it forward. When disassembling the ledger 3 and the transom 4, just remove the retaining clamp 11. The ledger flange 31 loses contact with retainer top section 103 so as to disconnect the ledger 3 and the transom 4.

Furthermore, the connection part 104 of the retainer 10 may be designed to various configurations to fit different configurations of the transoms.

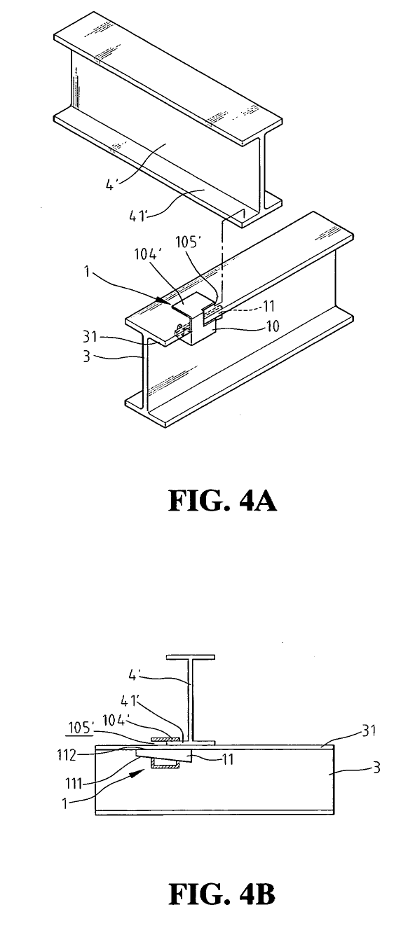

Referring to FIGS. 4A and 4B, according to a second preferred embodiment of the present invention, the framework connection set 1, which is almost the same as the one in the first embodiment, includes a retainer 10 and a retaining clamp 11. The retainer 10 herein do not have a retainer top section 103, but an inverted L-shaped connection part 104′ is directly connected to the edge of the retainer 10. There is a second opening 105′ between the retainer 10 and the connection part 104′ connected therewith. The ledger flange 31 is inserted into the first opening 100 and the transom flange 41′ of the I-shaped transom 4 is inserted into the second opening 105′. The ledger 3, the transom 4, retainer 10 and the retaining clamp 11 are connected all together by inserting a retaining clamp 11 onto the first groove 101 and the second groove 102 just like in the first preferred embodiment.

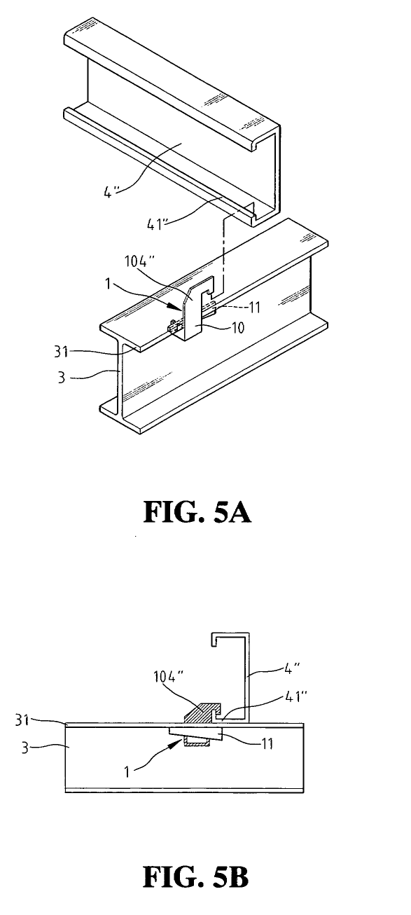

Referring to FIGS. 5A and 5B, according to a third embodiment of the present invention, the framework connection set 1, which is almost the same as the one in the first embodiment, includes a retainer 10 and a retaining clamp 11. The retainer 10 herein extends upward with a hook-shaped connection part 104″ directly from the side edge of the retainer 10. The hook-shaped connection part 104″ is used to fit the transom flange 41 ″ of the C-channeled transom 4″. All other respects of connection are the same as those in the first embodiment.

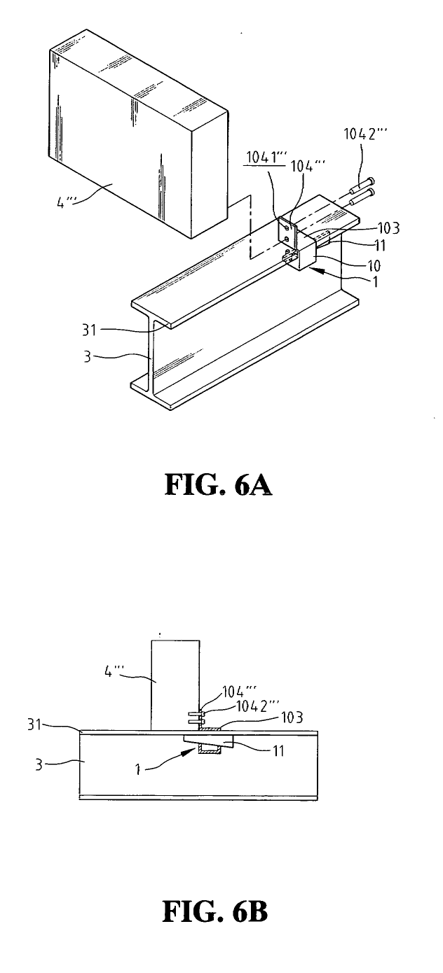

Referring to FIGS. 6A and 6B, according to a fourth embodiment of the present invention, the framework connection set 1, which is almost the same as the one in the first embodiment, includes a retainer 10 and a retaining clamp 11. The connection part 104′″ herein has at least a bolt hole 1041′″ for the transom 4′″ to be fasten to the retainer 10 by a bolt 1042′″.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A framework connection set, comprising:
a retainer provided with an approximately C-shaped foundation, at least a groove defined therein, an retainer top section, and at least a connection part connected therewith; and
a retaining clamp being a wedge;
wherein the retaining clamp is inserted onto or removed from the groove to make it close to or away from the retainer top section so as to assemble or disassemble the frameworks respectively.

2. The framework connection set as claimed in claim 1, wherein the retainer includes a first groove and a second groove, the depth of which is smaller than that of the first groove, and the first groove is provided with a groove convex and a groove concave, and wherein the retaining clamp includes a clamp slot which is corresponding to the groove convex and parallel to a clamp top surface, and a clamp ridge which is corresponding to the groove concave; when moving the retaining clamp onto both the first groove and the second groove, the retaining clamp is restrained therein, and the clamp slot and the clamp ridge slide along the groove convex and the groove concave respectively.

3. The framework connection set as claimed in claim 1, wherein the configuration of connection part of the retainer is corresponding to that of a transom.

4. The framework connection set as claimed in claim 3, wherein the connection part of the retainer is an inverted L shape.

5. The framework connection set as claimed in claim 3, wherein the connection part of the retainer is provided with a hole.

6. A framework connection set, comprising:
a retainer provided with an approximately C-shaped foundation, at least a groove defined therein, and a connection part connected with the edge of the retainer; and
a retaining clamp being a wedge;
wherein the retaining clamp is inserted onto or removed from the groove to make it close to or away from the connection part so as to assemble or disassemble the frameworks respectively.

7. The framework connection set as claimed in claim 6, wherein the retainer includes a first groove and a second groove, the depth of which is smaller than that of the first groove, and the first groove is provided with a groove convex and a groove concave, and wherein the retaining clamp includes a clamp slot which is corresponding to the groove convex and parallel to a clamp top surface, and a clamp ridge which is corresponding to the groove concave; when moving the retaining clamp onto both the first groove and the second groove, the retaining clamp is restrained therein, and the clamp slot and the clamp ridge slide along the groove convex and the groove concave respectively.

8. The framework connection set as claimed in claim 6, wherein the configuration of the connection part of the retainer is corresponding to that of a transom.

9. The framework connection set as claimed in claim 6, wherein there is an opening between the connection part and the retainer.

10. The framework connection set as claimed in claim 6, wherein the connection part of the retainer is an inverted L shape.

11. The framework connection set as claimed in claim 6, wherein the connection part of the retainer is a hook shape.
